(19) United States
(12) Patent Application Publication
(10) Pub. No.: US 2016/0343091 A1
(43) Pub. Date: Nov. 24, 2016

(54) CHARGING AND BILLING SYSTEM FOR ELECTRIC VEHICLE

(71) Applicant: Powercube Corporation

(72) Inventors: Chan Hee HAN, Gyeonggi-do (KR); Gyu Sik SHIN, Gyeonggi-do (KR)

(21) Appl. No.: 14/892,191

(22) PCT Filed: Mar. 28, 2014
(86) PCT No.: PCT/KR2014/002698

§ 371 Date: Nov. 18, 2015

(30) Foreign Application Priority Data
Nov. 9, 2013 (KR) 10-2013-0135930

(51) Int. Cl. G06Q 50/06; B60L 11/18; G06Q 30/04

(52) U.S. Cl. CPC G06Q 50/06; G06Q 30/04; B60L 11/1827; B60L 11/1824; B60L 2240/72

(57) ABSTRACT

A charging and billing system for an electric car systematically manages an electricity supplier who supplies electricity for charging and a consumer who uses electricity for charging and reasonably and accurately calculates a fee based on a criterion for calculating a fee for electricity used for charging. The charging and billing system for the electric car includes a billing system of an electric power company configured to supply electricity, a management operator configured to manage an electric supply unit installed by the electric power company for charging and to settle the fee for electricity used for charging with the electric power company, a mobile communication network configured to provide a communication service in connection with the management operator, and a settlement company configured to settle the fee for electricity used for charging. When the electric car is charged, the fee for electricity used for charging is offset between the management operator and the electric power company.

### TECHNICAL FIELD

The present invention relates to a charging and billing system for an electric car.

The present invention particularly relates to systematically managing an electricity supplier who supplies electricity for charging and a consumer who uses electricity for charging and reasonably and accurately calculating a fee depending on for which purpose the electricity is used.

### BACKGROUND ART

As electric cars have come into widespread use, infrastructure for charging an electric car needs to be established above all else.

In addition to charging facilities installed in apartments or general houses, many electricity charging points for easily charging electric cars anywhere at any time when determining that charging is needed should be installed.

No problem occurs when charging is performed via a legal electricity charging point However, when an electric car is charged via electric supply equipment provided in apartments or general houses, the following problems may occur.

In a general apartment, a plug (connected to an electric car) may be inserted into a socket provided in a space where an electric car is parked to perform charging. In this case, it is difficult for a billing company (e.g., Korea Electric Power Cooperation), which calculates a fee for use based on information such as the amount of used electric power, to check whether charging is performed (electric power is used) for the purpose of charging an electric car or for the purpose of charging home appliances. The same is true when the electric car is charged via a socket provided in a general house.

When the purpose of charging is not discriminated, in an electric fee system in which a fee progressively increases according to classes to which the amount of electricity belongs, the amount of electric power used for charging the electric car may be added to the amount of electric power used for charging home appliances, explosively increasing the electric fee due to increase in class to which the amount of electricity belongs.

When the electric car is charged in a state of solving such problems, residents living in apartments may suffer losses in the case of public electricity of apartments and residents living in general houses may suffer losses in case of the general houses.

### DISCLOSURE

### [Technical Problem]

Therefore, the present invention has been made in view of the above problems, and it is an object of the present invention to provide a charging and billing system for an electric car, which is capable of accurately recognizing specific electric supply equipment and an electric fee charging target such as an electric car to easily identify an electricity supplier and an electricity consumer.

Another object of the present invention is to provide a charging and billing system for an electric car, which is capable of reasonably and accurately billing a user according to the amount of electricity used for charging via specific electric supply equipment and the amount of electricity used for purposes other than charging.

Other objects of the present invention will be clearly understood from the following detailed description.

### [Technical Solution]

In accordance with an aspect of the present invention, the above and other objects can be accomplished by the provision of a charging and billing system for an electric car including an electric power company configured to supply electricity and calculate a fee according to an amount of electricity used, a management operator configured to manage an electric supply unit installed by the electric power company and to settle the fee for electricity used for charging with the electric power company, a communication network configured to provide a communication service between the management operator and a billing system, and a settlement company configured to settle the fee for electricity used for charging, wherein, when the electric car is charged via the electric supply unit, the fee for electricity used for charging is offset between the management operator and the electric power company.

In accordance with another aspect of the present invention, there is provided a charging and billing system for an electric car including an electric supply unit, the electric car being charged with electricity via the electric supply unit, a controller configured to electrically connect the electric supply unit and the electric car and to control charging of the electric car via the electric supply unit, and a billing unit configured to calculate a fee based on a criterion for calculating a fee for electricity used for charging the electric car via the electric supply unit.

The fee for electricity used for charging may be calculated according to a basic fee based on a time zone and an amount of electricity currently used.

In accordance with another aspect of the present invention, there is provided a charging device of an electric car including a connector configured to electrically connect the electric car to an electric supply unit in order to charge the electric car, a controller configured to control charging of the electric car and to share information on charging with a management operator and a billing unit, a manipulation unit manipulated for charging the electric car, and another connector electrically connected to the electric car.

The electric supply unit, the electric car and the charging device may be assigned unique IDs, respectively.

The unique ID assigned to the electric car may be sensed by the manipulation unit and processed by the controller.

The unique IDs respectively assigned to the electric supply unit and the electric car may be shared between a management operator and an electric power company.

### [Advantageous Effects]

According to a charging and billing system for an electric car of the present invention, systematic management is possible by recognizing an electric supply unit and an electric car to easily check an electricity supplier and an electricity consumer.

According to the present invention, it is possible to reasonably and accurately bill a user according to the amount of electricity used via an electric supply unit and the amount of electricity used for purposes other than charging.

According to the present invention, electric car charging infrastructure can be used only by registration with a server of a management operator for managing an electric supply unit so as to remarkably decrease cost required to establish the electric car charging infrastructure.

### DESCRIPTION OF DRAWINGS

The above and other objects, characteristics and other advantages of the present invention will be more clearly understood from the following detailed description taken in conjunction with the accompanying drawings, in which:

FIG. 1 is a diagram showing the whole configuration of a charging and billing system for an electric car according to the present invention;

FIG. 2 is a diagram showing the configuration of the charging and billing system for the electric car according to the present invention;

FIG. 3 is a diagram showing the configuration of a charging device of an electric car of FIG. 2;

FIG. 4a is a photograph of an electric car of FIG. 3;

FIG. 4b is a diagram illustrating recognition of an electric supply unit (socket) to which a charging device according to the present invention is connected;

FIG. 5 is a diagram showing the whole configuration of the present invention; and

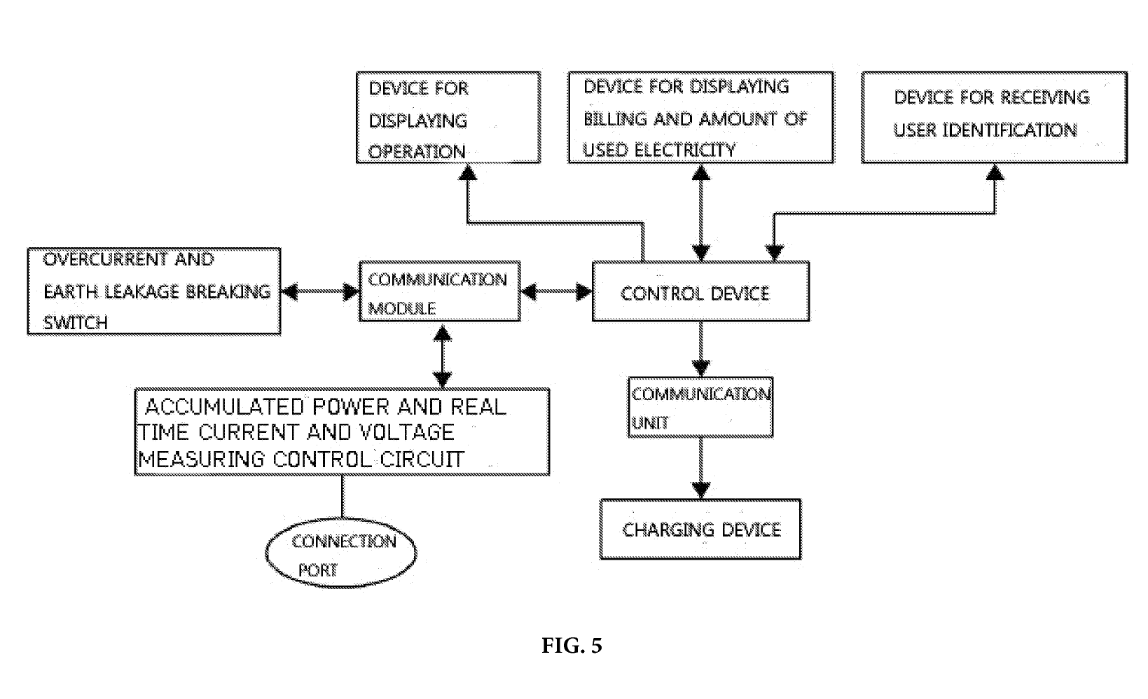

FIG. 6 is a flowchart illustrating operation of the present invention.

### BEST MODE

Hereinafter, embodiments of the present invention will be described in detail with reference to the accompanying drawings.

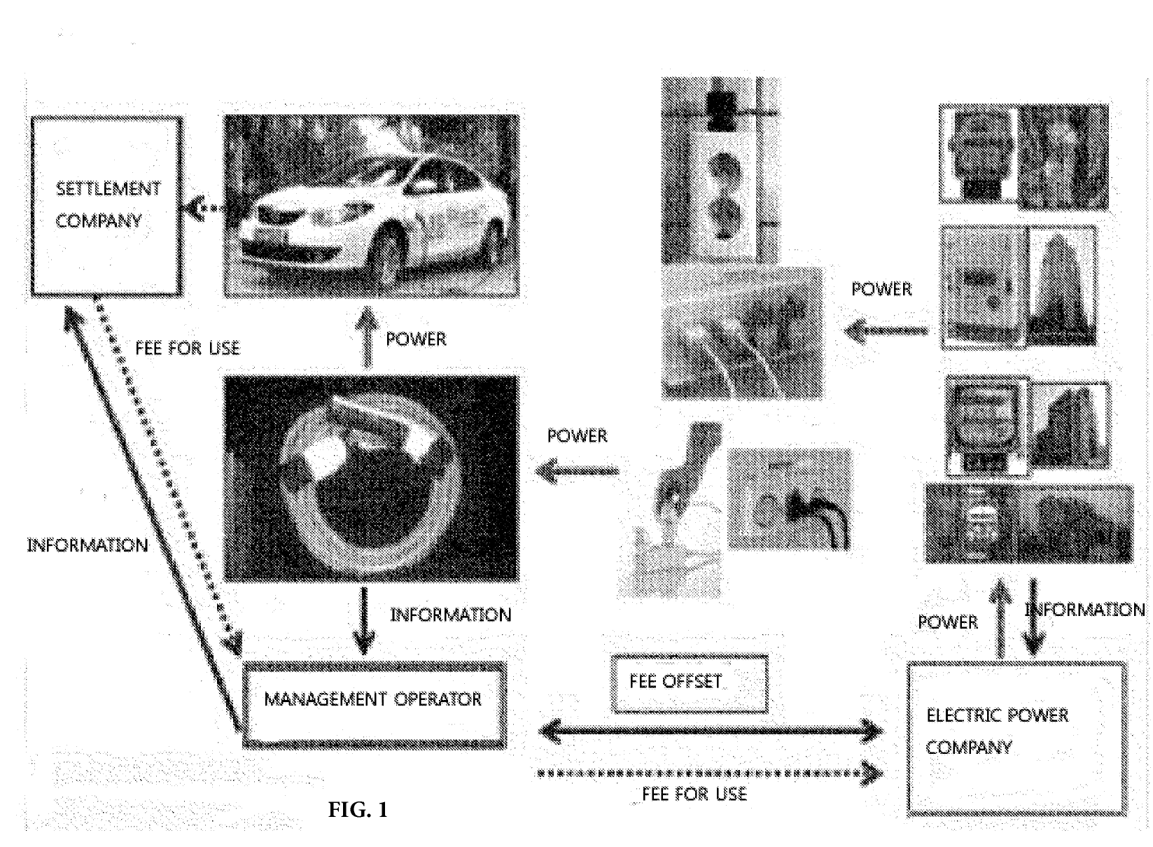

As shown in FIG. 1, a system for charging an electric car according to the present invention includes an electric power company for supplying electricity and calculating a fee according to the amount of electricity used; a management operator for managing an electric supply unit installed by the electric power company and settling the fee for electricity used for charging with the electric power company; a mobile communication provider for providing a communication service between the management operator and a billing system; and a settlement company for settling the fee for electricity used for charging. When the electric car is charged via an electric supply unit, the electric fee is offset between the electric supply operator and the company.

In the system of the present invention, the electric fee for electricity used for charging the electric car is offset between the electric power company and the management operator. A car requiring charging may freely use all electric supply units managed by the management operator and the electric fee may be reasonably calculated according to charging.

That is, the management operator registers, with a server, information (e.g., the identification number of the electric meter of the electric power company) on an electric supply unit (socket) installed in a predetermined building in order to charge an electric car and an electric meter connected to the electric supply unit in advance, and the electric power company imposes a fee excluding a fee for electricity used to charge the electric car on the owner of the building in consideration of the amount of electricity used to charge the electric car and the total amount of electricity measured via the electric meter of the electric power company.

The management operator bills the customer for the fees for electricity used for charging and gives some of the collected fees to the electric power company according to a rule defined between the management operator and the electric power company.

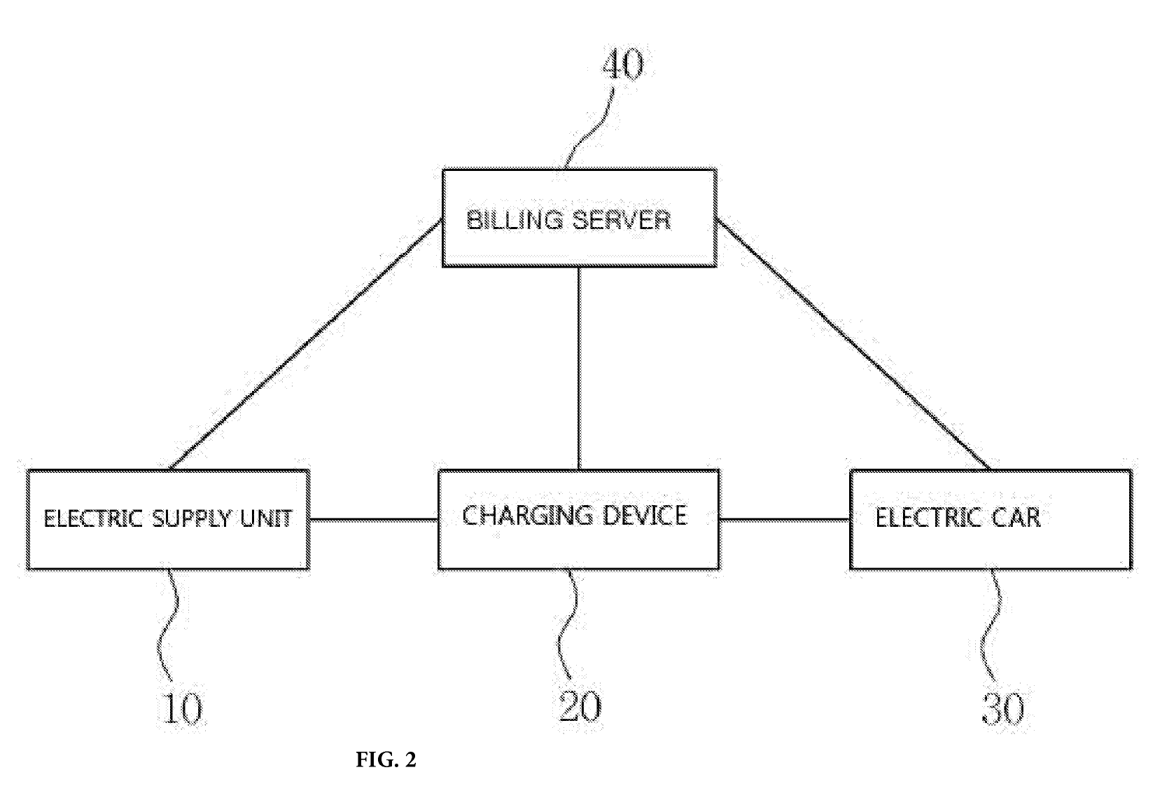

As shown in FIG. 2, the charging and billing system for the electric car according to the present invention includes a plurality of electric supply units 10, a plurality of electric cars 30, a controller 20 connected between the electric supply units 10 and the electric cars 30 to control electricity supply (charging) from the electric supply units 10 to the electric cars 30, and a billing server 40 for calculating fees according to the amount of electricity used for charging the electric car 30 via the electric supply unit 10 and the amount of electricity used generally. As shown in FIG. 1, the management operator, the mobile communication provider and the settlement company may be further included but will be omitted therein.

The electric supply units 10 are installed in buildings such as electric charging points, apartments and general houses and are sockets each having a plurality of connection ports connected to general electric products for use of external electricity supplied by the electric supply company and connected to the electric cars 30 for charging. The electric supply unit 10 may be connected to a meter different from the meter provided by the electric power company.

Although the electric supply unit 10 is generally fixed at a predetermined position, the electric supply unit 10 is movable if the charging device of the present invention is a portable electric supply unit connected to the socket.

Since the electric supply unit 10 supplies external electricity supplied by the electric power company to the general electric product or the electric car 30 for general use or charging, AC power is mainly supplied. However, when the mobile electric supply unit is used as described above, DC power may be supplied. In this case, the mobile electric supply unit includes an AC/DC converter.

The plurality of electric supply unit 10, the plurality of electric cars 30 and the charging device may be assigned respective unique IDs and managed.

The controller 20 stores and transmits information on the amount of electricity used for charging the electric car, information on a billing target such as an electric supply unit and an electric car and charging record information to the billing server 40 and the management operator. The controller includes a lamp and a speaker, for operation of a manipulation unit 60.

The controller 20 recognizes the state of the charging operation such as electrical connection between the electric supply unit 10 and the electric car 30 and charging or charging completion of the electric car 30, informs a user of the state of the charging operation via audio/video means and transmits information on the electric supply unit, information on the amount of electricity used for charging, information on the charging device and information on the electric car to the billing server 40 in order to reasonably calculate a fee based on the amount of electricity used and data necessary for calculating the other fees. This information is also transmitted to and managed by the management operator.

The controller 20 and the billing server 40 are connected via Wi-Fi, PLC, wireless communication or power-line communication and are selectively connected to each other via various communication networks such as a wired network or another network incurring a fee. In addition, the controller 20 and the management operator or the management operator and the billing server 40 are connected via a wired or wireless communication network.

The billing server 40 calculates a fee for use based on the information on the electric supply unit, the information on the amount of electricity used for charging, the information on the charging device and the information on the electric car received from the controller 20 and bills the user.

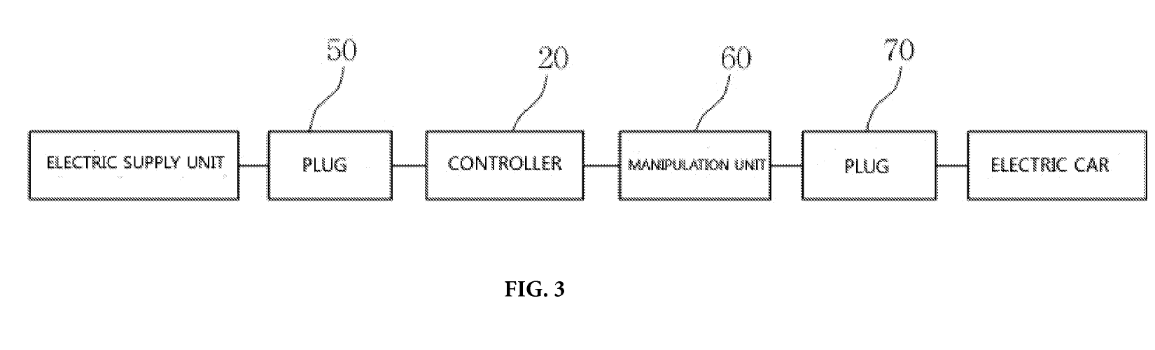

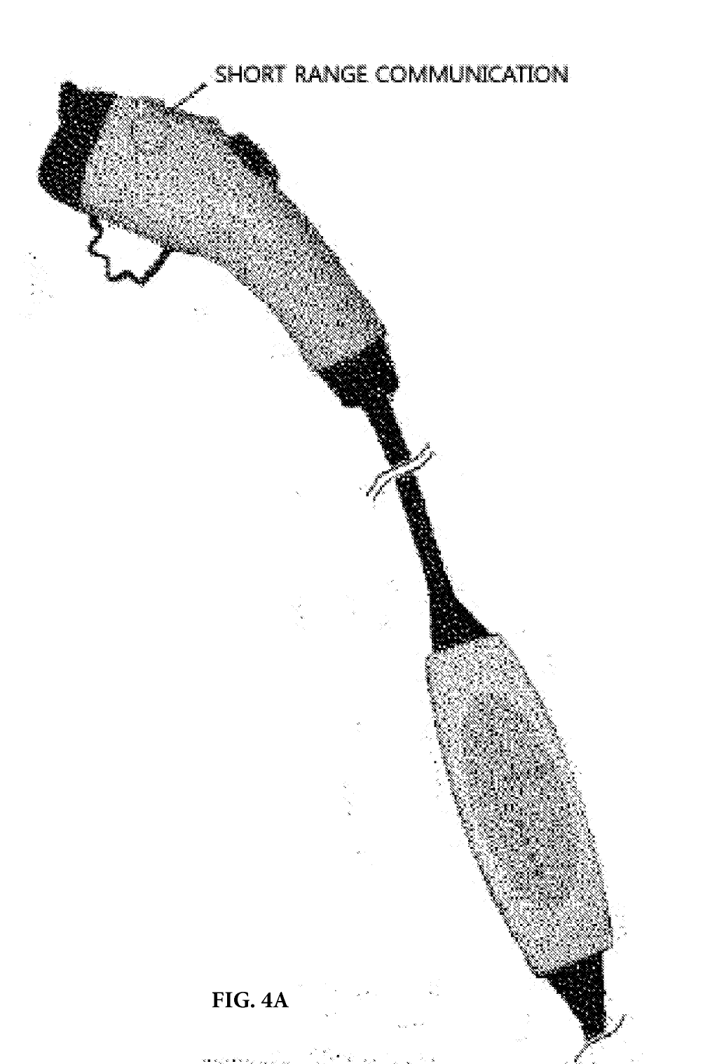

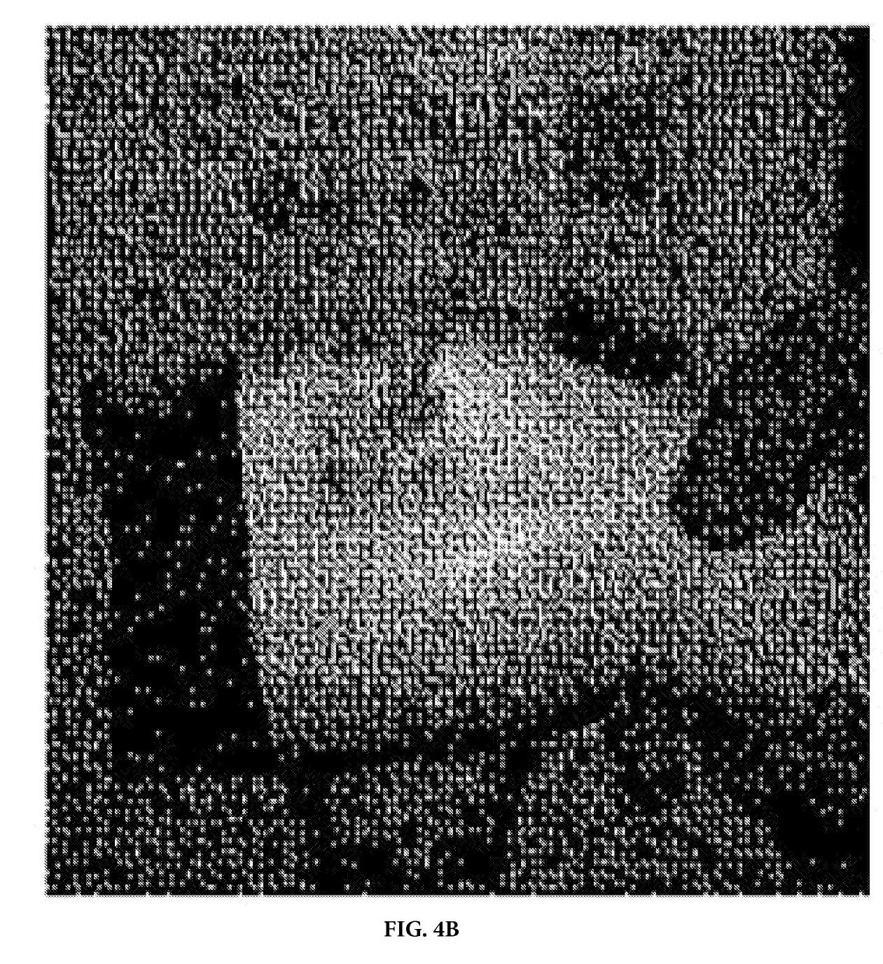

FIGS. 3, 4a and 4b show the electric charging device included in the system of FIG. 2, which includes a plug 50 electrically connected to the electric supply unit 10, a controller 20 for controlling charging of the electric car and performing communication with the billing server 40 and the management operator, a manipulation unit 60 manipulated for charging the electric car and a plug 70 electrically connected to the electric car 30. The plug 50, the controller 20, the manipulation unit 60 and the pug 70 are connected via an electric line and a data transmission line.

The controller 20 and the electric car 30 are equal to the components of FIG. 2.

As described above, the electric supply unit 10 is assigned a unique ID in the form of a barcode or RF card, for example. Different IDs are assigned to respective electric supply units 10 and managed. This means that the electric supply units installed at predetermined positions are assigned different IDs and managed. Accordingly, the electric supply unit for supplying charging electricity to the electric car is specified and recognized by the controller 20.

The ID is attached to a predetermined part of the electric supply unit 10 or in proximity thereof and a signal corresponding to the ID is stored in and managed by the billing server 40, for association with the controller 20 and the billing server 40. For example, as shown in FIG. 4b, when an identification tag, such as a barcode, for storing information on the electric supply unit is attached to the electric supply unit or in proximity thereof, the plug 50 of the charging device recognizes the identification tag to calculate the amount of electricity used for charging via the electric supply unit and the fee for electricity used for charging.

The recognition of the controller 20 is possible when the electric supply unit 10 and the electric car 30 are connected via the controller 20, that is, when the plug 50 connected to the controller 20 is electrically connected to the electric supply unit 10.

As described above, the electric car 10 is assigned a unique ID in the form of a barcode or RF card and different IDs are assigned to the respective electric cars 30. Accordingly, the controller 20 distinguishably recognizes IDs.

The ID is attached to a predetermined part of the electric car 30, and a signal corresponding to the ID is stored in and managed by the controller 20 and the billing server 40, for association with the controller 20 and the billing server 40.

Similarly to the above description, recognition of the controller 20 is possible when the electric supply unit 10 and the electric car 30 are connected via the charging device, that is, when the plug 70 connected to the controller 20 is electrically connected to the electric car 30.

The manipulation unit 60 is not limited to a specific type and may be of a button type or a push type. The manipulation unit is provided between the controller 20 and the plug 70 connected to the electric car 30 and is manually manipulated when the electric supply unit 10 and the electric car 30 are electrically connected.

The manipulation unit 60 may be manipulated such that a message “connection is established for charging”, “charging is being performed” or “charging has finished” is displayed after being processed in the controller 20.

The manipulation unit 60 has a sensor (not shown) for sensing the unique ID of the electric car and identifies a specific electric car to be charged by processing the ID signal sensed by the sensor in the controller 20.

According to the charging and billing system for the electric car of the present invention, the electric car 30 can be charged via all electric supply units 10 regardless of place.

Since the electric supply units 10 and the electric cars 30 all have respective unique IDs and the IDs are stored in and managed by the controller 20 and the billing server 40, the electricity supplier (e.g., an electric fee payer such as an owner of a general house or an apartment) and the electricity consumer (e.g., an electric fee payer such as an owner of an electric car) are systematically classified and recognized upon charging the electric car 30 via the electric supply unit 10.

In addition to such operation, the present invention enables reasonable billing. The electric fee includes a basic fee and an energy fee. The electric fee is decided by adding an industrial foundation fund of an electric power industry and an added-value tax to a sum of the basic fee and the energy fee.

The basic fee and the energy fee vary according to electric supply methods (high voltage, low voltage) and contract classifications (for a house, general use, industry, education, or agriculture).

In the electric power for the house, the basic fee is divided into six classes according to usage, the energy fee is divided into six classes, and a progressive rate is applied.

Since the basic fee is applied based on contract power in all contract classifications except for the electric power for the house, the contract power becomes fee-applying power which is a criterion for calculating a fee.

For a customer having a maximum demand power meter, maximum demand power of July, August and September of preceding 12 months including a month when the electric meter is read and the month when the electric meter is read is set as fee-applying power and the basic fee is calculated based on the fee-applying power.

Since the electric fee is calculated using such a complicated method, when the electric car is charged via the electric supply unit installed at a specific position, the electric fee is reasonably calculated in consideration of the fee calculation method used in the electric supply unit.

This is because the basic fees, use times and the amounts of electricity used for the electric supply units installed at every position may be different and thus the electric fee may be differently calculated.

Accordingly, in the present invention, in consideration of different electric fee calculation criteria, such information is stored in and managed by the billing unit such that the fee is reasonably calculated and charging is configured to start in a state of checking the basic fee based on a time zone and the amount of electricity used. For example, the billing server 40 calculates the electric fee in consideration of a cumulative amount according to load, thereby enabling reasonable and accurate billing.

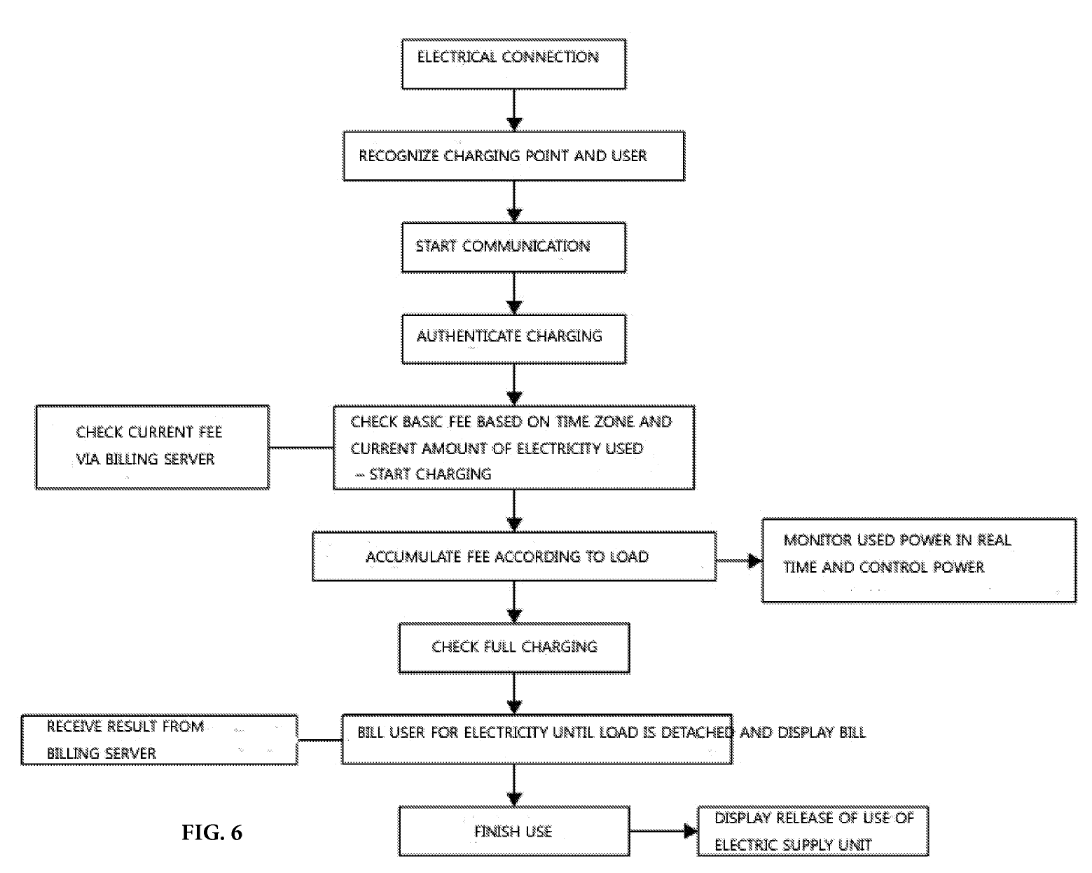

Operation of the charging device and the billing system using the same according to the present invention will now be described with reference to FIG. 6.

As shown in FIG. 6, when electrical connection is established, that is, when the plug 50 is connected to the electric supply unit 10 and the plug 70 is connected to the electric car 30, the IDs or RF cards assigned to the electric supply unit 10 and the electric car 30 are sensed by the plug 50 and the manipulation unit 60 and processed by the controller 20 to identify the electricity supplier and the electricity consumer.

That is, which electric car is charged with electricity through which electric supply unit is determined.

In a state of determining which electric car is charged with electricity through which electric supply unit, communication between the controller 20 and the billing server 40 starts to authenticate charging, and charging starts after the basic fee based on the time zone and the amount of electricity currently used is accurately checked.

The fee based on the amount of electricity used is accumulated in real time during charging and is transmitted to the billing server 40 via the controller 20. Such operation is continuously performed until the load is detached, that is, the plug 50 is detached from the electric supply unit 10. Such operation is displayed on the display unit of the controller 20 such that the user recognizes progress of the operation.

When charging finishes, use of the electric supply unit is released under control of the controller 20 and the billing server 40 bills the user for electricity used for charging.

Thereafter, the user pays the bill.

Since the present invention may have various modifications and various embodiments, specific embodiments are shown in the drawings and described in the detailed descriptions. However, the present invention is not limited to the specific embodiments, those skilled in the art will appreciate that various modifications, additions and substitutions are possible, without departing from the scope and spirit of the invention as disclosed in the accompanying claims

1. A charging and billing system for an electric car comprising:
an electric power company configured to supply electricity and calculate a fee according to an amount of electricity used;
a management operator configured to manage an electric supply unit installed by the electric power company and to settle the fee for electricity used for charging with the electric power company;
a communication network configured to provide a communication service between the management operator and a billing system; and
a settlement company configured to settle the fee for electricity used for charging,
wherein, when the electric car is charged via the electric supply unit, the fee for electricity used for charging is offset between the management operator and the electric power company.

2. A charging and billing system for an electric car comprising:
an electric supply unit;
the electric car being charged with electricity via the electric supply unit;
a controller configured to electrically connect the electric supply unit and the electric car and to control charging of the electric car via the electric supply unit; and
a billing unit configured to calculate a fee based on a criterion for calculating a fee for electricity used for charging the electric car via the electric supply unit.

3. The charging and billing system for the electric car according to claim 1, wherein the fee for electricity used for charging is calculated according to a basic fee based on a time zone and an amount of electricity currently used.

4. A charging device of an electric car comprising:
a connector configured to electrically connect the electric car to an electric supply unit in order to charge the electric car;
a controller configured to control charging of the electric car and to share information on charging with a management operator and a billing unit;
a manipulation unit manipulated for charging the electric car; and
another connector electrically connected to the electric car.

5. The charging device according to claim 4, wherein the electric supply unit, the electric car and the charging device are assigned unique IDs, respectively.

6. The charging device according to claim 5, wherein the unique ID assigned to the electric car is sensed by the manipulation unit and processed by the controller.

7. The charging device according to claim 5, wherein the unique IDs respectively assigned to the electric supply unit and the electric car are shared between a management operator and an electric power company.
